(19) United States
(12) Patent Application Publication
(10) Pub. No.: US 2004/0203373 A1
(43) Pub. Date: Oct. 14, 2004

(54) Wireless terminal device, communications system, and communication control method

(76) Inventors: Minoru Ogino, Kawasaki-shi (JP); Toshiaki Fujikura, Urayasu-shi (JP); Katsunori Yamamoto, Yachiyo-shi (JP)

Correspondence Address: MCDERMOTT WILL & EMERY LLP, 600 13TH STREET, N.W., WASHINGTON, DC, 20005-3096, US

(21) Appl. No.: 10/280,079

(22) Filed: Oct. 25, 2002

(30) Foreign Application Priority Data
Jul. 31, 2002 (JP) 2002-222825

(51) Int. Cl. H04Q 7/20

(52) U.S. Cl. 455/41.2; 370/338; 455/553.1

(57) ABSTRACT

Provided is a wireless terminal device and a communications system that is able to maximize the effect of expanding the communication availability range by interposing a virtual base station. The wireless terminal device of this invention is used in a communications system where one terminal in a group of terminals becomes a master station, and the remaining terminals become slave stations. The wireless terminal device with switchable operation modes comprises at least: a standby mode for performing communications within the group and obtaining information regarding a terminal that is able to communicate with its own terminal; a master station mode; and a slave station mode. The wireless terminal device further comprises: a first unit for obtaining another terminal's communication-possible terminal information, selecting a candidate terminal for the master station on the basis of the respective terminals' communication-possible terminal information, and notifying other terminals of the selection results; and a second unit for, on the basis of the selection results, switching its mode to master station mode when its own terminal is selected as the candidate terminal for the master station, and switching its mode to slave station mode when its own terminal is not selected as such.

### BACKGROUND OF THE INVENTION

1. Field of the Invention

The present invention relates to a communications system where plural wireless terminal devices form a group and one terminal in the group becomes a master station while the remaining terminals become slave stations, thereby performing communications between the master station and the slave stations.

2. Description of the Related Art

There are two conventional types of the communications systems such as wireless LAN systems, a distributed type and a centralized type, in which plural wireless terminal devices intercommunicate. A distributed system is a type in which all of the wireless terminal devices perform the peer-to-peer communications. An example of the distributed system is communications between transceivers. A centralized system is a type in which a base station carries out the communications control of mobile stations. For example, communications using the personal handy phone (PHS) and communications with mobile phones fall onto this type. The usage pattern of the communications system and other information are considered to decide which system mode to adopt, thereby providing optimal system designing.

### SUMMARY OF THE INVENTION

With the distributed communications system, the maximum distance at which communication is possible is determined in accordance with the specifications of a terminal itself, therefore; the communication-possible range is not always broad. On the other hand, in the centralized communications system, the communication-possible range can be expanded by interposing abase station. However, this range is determined in accordance with the location of the base station, therefore; the lack of flexibility causes.

In order to solve the above problem, there is a method of not establishing a dedicated base station, but instead making any one of the plural terminals operate as a virtual base station. For example, a highly flexible and versatile communications system can be built by adopting a structure in which plural wireless terminal devices form a group and one terminal in the group becomes a master station (a virtual base station), while the remaining terminals become slave stations in order to perform communications between the master station and the slave stations.

In the aforementioned structure, in order to maximize the effect of expanding the communication-possible range by interposing the virtual base station, it is extremely important which terminal is selected as the virtual base station. This is because the communication-possible range, accordingly, the combination of terminals that can communicate each other, is determined in accordance with the location of the virtual station in the group. For example, in a case where the respective terminals are positioned as shown in FIG. 2, if the terminal 4 becomes the virtual base station, the terminal 1 is not be able to communicate with the virtual base station. Accordingly the terminal 1 can not make a call to the other terminals with the virtual base station interposed.

In order to maximize the effect of broadening the communication-possible range by interposing the virtual base station, it is an object of this invention to provide a wireless terminal device having selection criteria for a virtual base station and the function to select the virtual base station on the basis of the selection criteria, as well as a communications system therefor.

The wireless terminal device of this invention is characterized in that it is used in a communications system wherein a plurality of wireless terminal devices form a group; one terminal in the group becomes a master station; and the remaining terminals become slave stations, thereby performing communications between the master station and the slave stations. The wireless terminal device comprises switchable operation modes including at least: a standby mode for performing communications within the group and obtaining information regarding a terminal that is able to communicate with its own terminal (hereinafter referred to as the “communication-possible terminal information”); a master station mode for operating as the master station; and a slave station mode for operating as the slave station. The wireless terminal device further comprises: a first unit for obtaining another terminal's communication-possible terminal information, selecting a candidate terminal for the master station on the basis of the respective terminals communication-possible terminal information, and notifying other terminals of the selection results; and a second unit for, on the basis of the selection results, switching to master station mode when its own terminal is selected as the candidate terminal for the master station, and switching to the slave station mode when its own terminal is not selected as such.

Preferably, concerning the above wireless terminal device, the communication-possible terminal information will include information of the number of terminals that are able to communicate with its own terminal or the identification information of said terminals.

Preferably, on the basis of the transmission timing assigned to the respective terminals in the group, when the wireless terminal device of this invention is in the standby mode, it transmits a signal at the timing assigned to its own terminal; receives a signal at the timing assigned to another terminal; and adjusts the transmission and reception timing on the basis of the received signal. Here, it is preferable that the signal includes the communication-possible terminal information.

The communications system of this invention is the system wherein a plurality of wireless terminal devices form a group; one terminal in the group becomes a master station; and the remaining terminals become slave stations, thereby performing communications between the master station and the slave stations. In the system, the wireless terminal device comprises switchable operation modes including at least: a standby mode for performing communications within the group and obtaining information regarding a terminal that is able to communicate with its own terminal; a master station mode for operating as the master station; and a slave station mode for operating as the slave station. In the system, the wireless terminal devices further comprises: a first unit for obtaining another terminal's communication-possible terminal information, selecting a candidate terminal for the master station on the basis of the respective terminals' communication-possible terminal information, and notifying other terminals of the selection results; and a second unit for, on the basis of the selection results, switching its mode to master station mode when its own terminal is selected as the candidate terminal for the master station, and switching its mode to slave station mode when its own terminal is not selected as such.

The communication control method of the wireless terminal device of this invention is characterized in that it is used for a communications system wherein a plurality of wireless terminal devices form a group; one terminal in the group becomes a master station; and the remaining terminals become slave stations, thereby performing communications between the master station and the slave stations. The communication control method of the wireless terminal device comprises the steps of: performing communications within the group and obtaining information regarding a terminal that is able to communicate with its own terminal; obtaining another terminal's communication-possible terminal information, selecting a candidate terminal for the master station on the basis of the respective terminals' communication-possible terminal information, and notifying other terminals of the selection results; and switching its mode, on the basis of the selection results, to master station mode when its own terminal is selected as the candidate terminal for the master station, and to slave station mode when its own terminal is not selected as such.

The communication control method of this invention is characterized in that it is for a communications system wherein a plurality of wireless terminal devices form a group; one terminal in the group becomes a master station; and the remaining terminals become slave stations, thereby performing communications between the master station and the slave stations. The communication control method of the wireless terminal device comprises: a step in which each terminal performs communications within the group and obtains information regarding a terminal that is able to communicate with its own terminal; a step in which a first terminal obtains another terminal's communication-possible terminal information; selects a candidate terminal for the master station on the basis of the respective terminals' communication-possible terminal information; and notifies other terminals of the selection results; and a step in which each terminal switches its mode, on the basis of the selection results, to master station mode when its own terminal is selected as the candidate terminal for the master station, and to slave station mode when its own terminal is not selected as such.

The program of this invention is characterized in that each step in the communication control method of this invention is executed by a computer contained in a wireless terminal device. The program of this invention can be installed or loaded into the computer that is contained in the wireless terminal device, through various recording media such as CD-ROMs, magnetic disks, and semiconductor memories, or through communications networks.

The data transmitted and received by the wireless terminal devices is not limited to audio signals, but it can be various types of data such as image data. The signal transmission method for transmitting signals between the terminals, can be arbitrarily chosen from or adopted by combining various conventional methods such as Time Division Duplex (TDD), Frequency Division Duplex (FDD), Time Division Multiple Access (TDMA), Frequency Division Multiple Access (FDMA), and Code Division Multiple Access (CDMA).

### BRIEF DESCRIPTION OF THE DRAWINGS

FIG. 1 is a block diagram of the wireless terminal device according to Embodiment 1 of this invention.

FIG. 2 is a diagram illustrating an example of the communication-possible range of each terminal.

FIG. 3 is a diagram illustrating an example of the operation sequence upon commencing the master/slave communications system.

FIG. 4 is a timing chart for system synchronization utilizing the heart-beat method.

FIG. 5 is a diagram illustrating an example of the structure of the time slot using the TDMA method.

FIG. 6 is a diagram illustrating the state in which the one-to-one communications are executed by using the time slot structure shown in FIG. 5.

FIG. 7 is a diagram illustrating the state in which the one-to-N communications are executed by using the time slot structure shown in FIG. 5.

FIG. 8 is a diagram showing another example of the operation sequence upon commencement of the master/slave communications system.

FIG. 9 is a diagram illustrating yet another example of the operation sequence upon commencement of the master/slave communications system.

### BEST MODE FOR CARRYING OUT THE INVENTION

(Embodiment 1)

An embodiment of this invention is explained hereinafter with reference to the relevant drawings, by utilizing an example of a communications system that performs communications between wireless terminal devices (for example, digital transceivers) without through the medium of a dedicated base station.

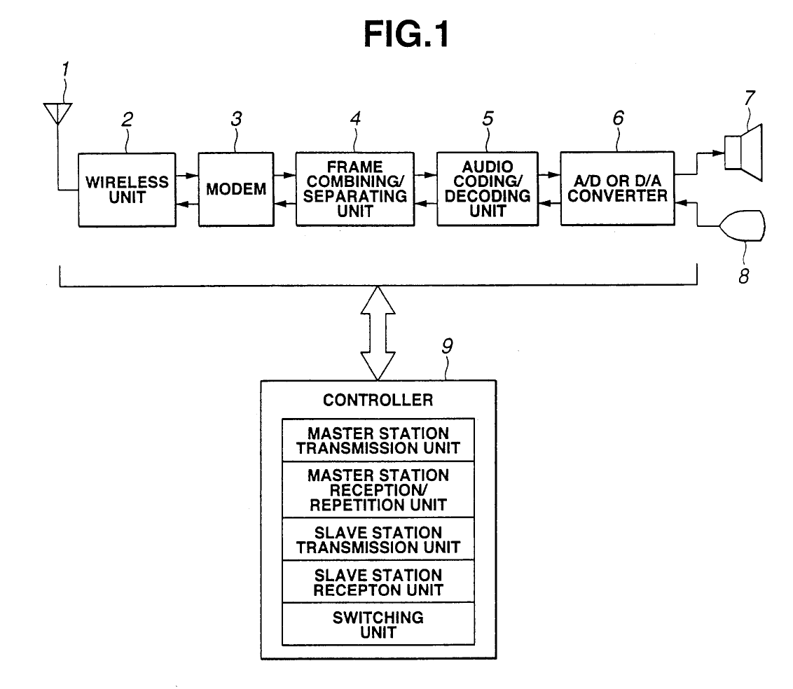

FIG. 1 is a block diagram of the wireless terminal device of Embodiment 1. As shown in FIG. 1, the wireless terminal device includes an antenna 1, a wireless unit 2 that is connected to the antenna 1, a modem 3, a frame combining/separating unit 4, an audio coding/decoding unit 5, an A/D or D/A converter 6, a speaker 7, a microphone 8, and a controller 9. In addition to those parts shown in FIG. 1, the wireless terminal device may also comprise constituting elements of which an ordinary wireless device is comprised, for example, an automatic gain controller, an echo canceller, a VOX detector, and an external connection interface.

As a general rule, the structure and operation of the each component mentioned above, are similar to the structure and operation of a conventional wireless terminal device.

For example, upon transmitting audio signals, the audio signals that have been input from the microphone 8, are converted into digital signals by the A/D or D/A converter 6 under the control of the controller 9. The digital signals are audio-coded by the audio coding/decoding unit 5, and the audio-coded signals are combined into a frame at a specified transmission timing by the frame combining/separating unit 4, and the signals are then transmitted to the modem 3. Thereafter, the signals are modulated by the modem 3 under a specified rule, and the frequency of the signals is converted into a transmission frequency by the wireless unit 2. Then, the modulated signals are transmitted to another wireless terminal device from the antenna 1.

Upon receiving audio signals, for example, the frequency of the signals received through the antenna 1 is converted by the wireless unit 2 under the control of the controller 9. The signals are demodulated by the modem 3, and are separated from the frame at a specified reception timing using the frame combining/separating unit 4, and the separated signals are then decoded by the audio coding/decoding unit 5. Thereafter, the signals are converted into analog audio signals by the A/D or D/A converter 6, and are then output as sounds from the speaker 7.

On the basis of the constitution and operations of the aforementioned parts, the wireless terminal device of this invention can perform the one-to-one communications in a similar manner to an ordinary wireless terminal device. Moreover, the wireless terminal device of this invention can build a communications system (hereinafter referred to as the “master/slave communications system”) where plural wireless terminal devices form a group and one terminal in the group becomes a master station (a virtual base station) while the remaining terminals become slave stations; thereby, performing communications between the master station and the slave stations.

As for operation modes for the master/slave communications system, the wireless terminal device of Embodiment 1 is capable of operating in any one of the following modes: a standby mode; a master station mode; and a slave station mode. The wireless terminal device stores programs, such as a program having the operational procedures in the respective modes, and a program for switching the operation modes. The controller 9 executes each program, thereby realizing operations in each mode and switching operations on the wireless terminal device. FIG. 1 shows the operations in each mode and the switching operations, which are respectively construed as respective functioning units.

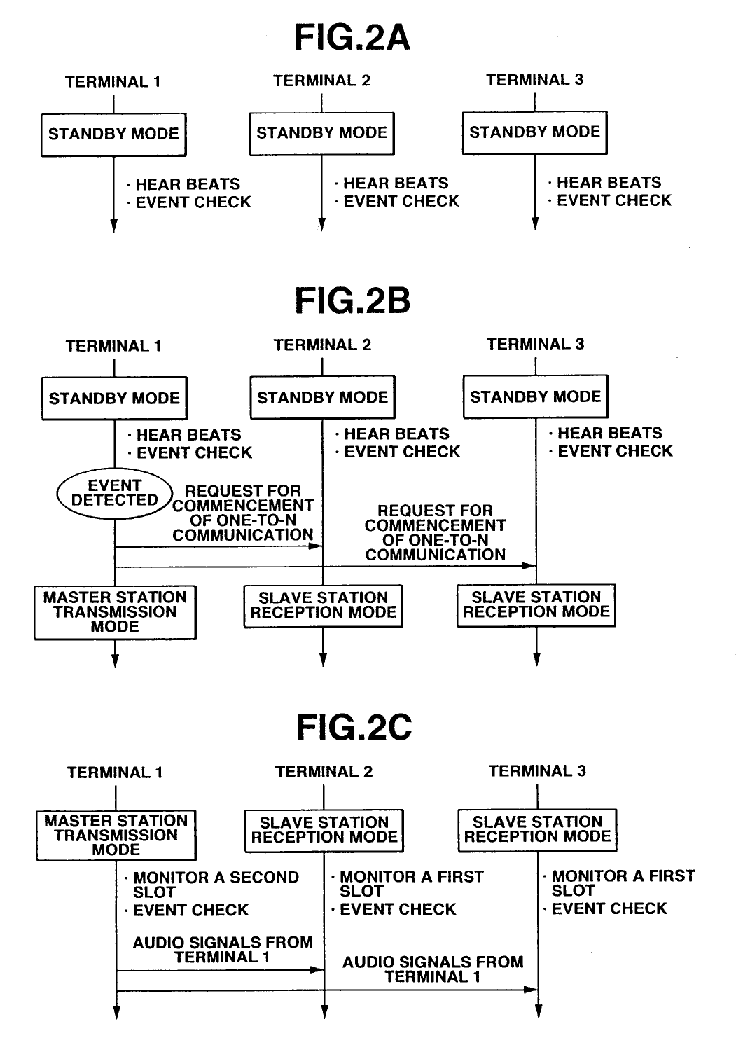

Hereinafter, the operations of each wireless terminal device in the master/slave communications system, are explained in detail with reference to FIGS. 2 to 9, by showing an example case in which five wireless terminal devices form a group. In this example in Embodiment 1, as shown in FIG. 2, the terminal 1 and the terminal 4 are respectively located outside each other's communication-possible range. In other words, the terminals 1 and 4 are situated in a positional relationship that does not allow direct one-to-one communications. The terminal 3 and the terminal 5 are also in the same positional relationship. FIG. 2 shows only one group, however, it is also possible to build plural master/slave communications systems by using different channels; forming plural groups at the same time; and providing master stations in the respective groups.

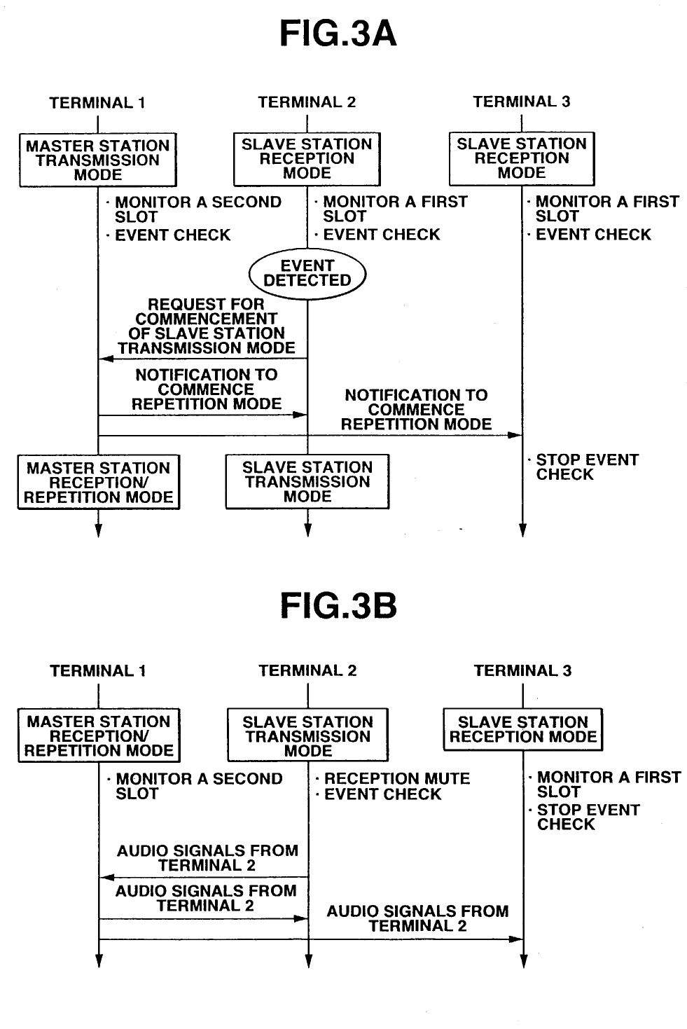

(Standby Mode: FIG. 3)

When, for example, a specified event (such as a key input) has been detected, the wireless terminal device brings standby mode into operation.

While operating in standby mode, each wireless terminal device monitors the channel, which had been decided by the group in advance, while obtaining system synchronization using the heart-beat method, and waits for a call to be started.

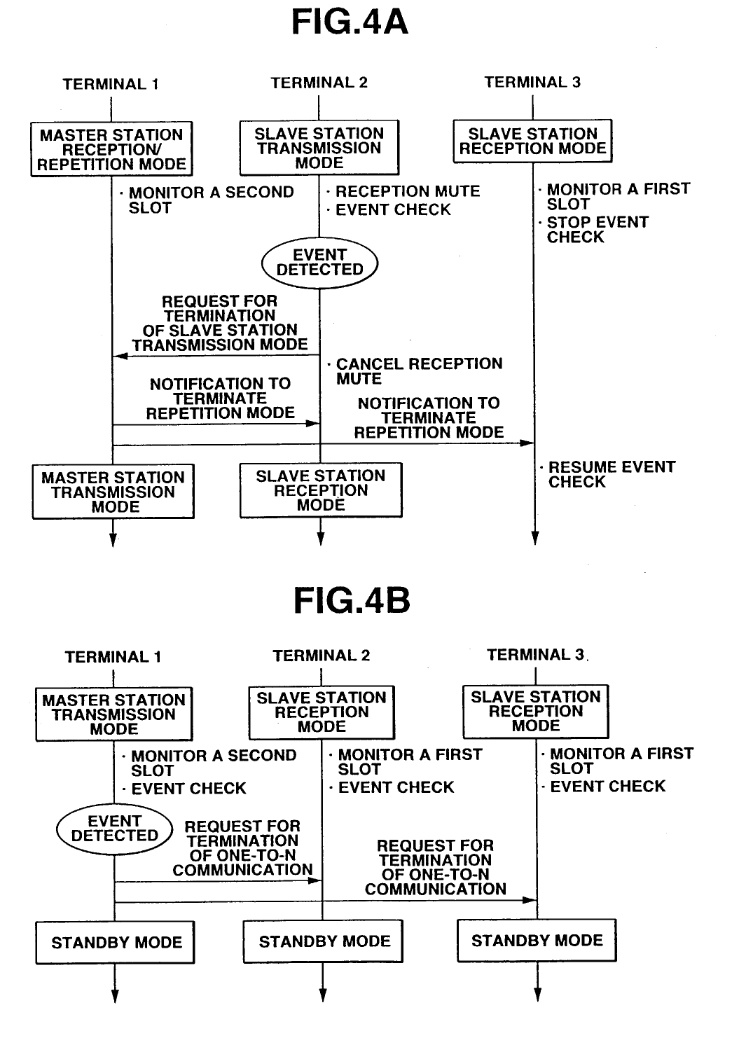

FIG. 4 is a timing chart for system synchronization using the heart-beat method. As shown in the figure, in the timing that takes up a full cycle P1, each terminal device has a fixed transmission timing that takes up a basic cycle P2. It is decided that terminal devices 1 to 5 take turns to become a transmission terminal. In short, in cycle 1, the terminal device 1 is the transmission terminal while the terminal devices 2 to 5 are the reception terminals. In the next cycle 2, the terminal device 2 is the transmission terminal while the terminal devices 1 and 3 to 5 are the reception terminals. Each terminal device, when it is in the cycle where it functions as the reception terminal, receives data from the transmission terminal and adjusts the reception cycle (reception timing) on the basis of the data. Thus, when using the heart-beat method, system synchronization is not obtained through a dedicated standard station, but each terminal device takes turns to become the standard station, Accordingly, each wireless terminal device is able to respond to an ever-changing wireless environment.

Moreover, in Embodiment 1, while operating in standby mode, each wireless terminal device executes processing to check its communications status. Specifically, each wireless terminal device counts the number of terminals in the group that is able to receive data (the number of communication-possible terminals); measures the number of communication-possible terminals for the most recent full cycle (or the maximum, minimum, or average number of communication-possible terminals for the past few full cycles); and stores the number in itself. In the FIG. 2 example, the terminal 1 can receive the data from the terminals 2, 3, and 5. As a result, the terminal 1 stores the number, 3, as the number of communication-possible terminals. Similarly, the terminals 2, 3, 4, and 5 store the numbers, 4, 3, 3, and 3, respectively as the numbers of communication-possible terminals.

(Commencement of Master/Slave Communications System: FIG. 3)

In Embodiment 1, a wireless terminal device that operates as the master station, is not fixed and an arbitrary wireless terminal device operating in standby mode can transfer its mode to master station mode. However, in the group of the wireless terminal devices, only one wireless terminal device can operate in master station mode. The remaining wireless terminal devices operate as slave stations.

The description assumes that terminal 1 operating in standby mode, detected a specified event (for example, a key input or an audio input from the microphone 8) that indicates the commencement of a call. In this case, the terminal 1 transmits, on the basis of the timing assigned to the terminal 1 of the channel, a request to the terminals 2 to 5 to transmit it the information of the number of communication-possible terminals. A conventional technique, such as VOX detection, can be employed to detect audio inputs.

On the basis of the timing assigned to terminal 1 of the channel, the terminals 2, 3, and 5 monitor the channel and receive a request from the terminal 1 to transmit the information of the number of communication-possible terminals to it. In this case, the terminals 2, 3, and 5 respectively read the information of the number of communication-possible terminals stored therein, and transmit the information of the number to the terminal 1 on the basis of the timing assigned to the respective terminals of the channel. Since the terminal 4 and the terminal 1 are in a positional relationship that does not allow direct communication, the terminal 4 can not receive the request from the terminal 1. Accordingly, the information of the number of communication-possible terminals of the terminal 4 can not be transmitted to the terminal 1 from the terminal 4.

The terminal 1 monitors the channel and can receive the information of the number of communication-possible terminals from the respective terminals on the basis of the timing assigned to the respective terminals. In Embodiment 1, the terminal 1 can obtain the information of the numbers of communication-possible terminals for all of the terminals except the terminal 4.

In this case, the terminal 1 compares the number of communication-possible terminals for itself with that of the number of communication-possible terminals for the other terminals, and selects, as a master station candidate terminal, the terminal that has the largest number of communication-possible terminals. If there is more than one terminal with the same number, the terminal 1 selects a terminal on the basis of the priority sequence (for example, the sequence of the terminal's identification numbers) assigned to each terminal. In this example in Embodiment 1, (the number of communication-possible terminals of the terminal 1, that of the terminal 2, that of the terminal 3, that of the terminal 4, that of the terminal 5)=(3, 4, 3, unknown, 3), therefore; the terminal 2 is selected as a master station candidate terminal.

Next, the terminal 1 transmits the information regarding the master station candidate to the terminals 2 to 5, on the basis of the timing assigned to the terminal 1 of the channel. When the terminal 1 itself is selected as a master station candidate, it switches to master station mode. When it is not selected as such, it switches to slave station mode. In the case of Embodiment 1, the terminal 1 is not selected as a master station candidate, therefore; the terminal 1 switches to slave station mode.

The terminals 2, 3, and 5 monitor the channel, and can receive information regarding the master station candidate from the terminal 1. In this case, the terminals 2, 3, and 5 respectively execute the following processing: when its own terminal is selected as a master station candidate, it changes to master station mode. If none of the terminals are selected as such, they switch to slave station mode. In this example in Embodiment 1, the terminal 2 switches to master station mode since it is selected as the master station candidate. The terminals 3 and 5 switch to slave station mode since they are not selected as such. As described before, the terminals 1 and 4 are in a positional relationship that does not allow direct communications, therefore; the terminal 4 can not receive information regarding the master station candidate from the terminal 1 and does not switch its mode at this time.

The terminal 2, which has switched to master station mode, transmits notification of its transition to master station to the terminals 1 and 3 to 5, on the basis of the timing assigned to the terminal 2 of the channel.

The terminals 1 and 3 to 5 monitor the channel and can receive notification of transition to the master station from the terminal 2. The transition notification informs the terminals 1 and 3 to 5 that the master/slave communications system has commenced in the group and that the terminal 2 is operating as the master station.

The terminal that is not able to receive information regarding the master station candidate and has not yet switched its mode (i.e. the terminal 4 in this example), switches to slave station mode upon considering the transition notification to be a trigger. Similarly, an alternative structure may be adopted where the other terminals (the terminals 3 and 5 in this example) also switch to slave station mode by perceiving the transition notification as a trigger. In this case, the terminal 1 only has to transmit the information regarding the master station candidate to the terminal 2, which is the master station candidate.

As described, the structure of Embodiment 1 is such that the respective terminals perform communications while they are operating in standby mode in order to obtain the information of the number of communication-possible terminals on the basis of the communication status; and, upon making a call, the terminal that has the maximum number of communication-possible terminals is selected to be operate as the master station. Accordingly, compared with the structure in which the master station is decided without providing any criterion, the structure of Embodiment 1 can maximize the number of terminals that can communicate with the call-commencing terminal; thereby maximizing the effect of expanding the communication-possible range by interposing the master station.

(Operations in the Master/Slave Communications System)

While the master/slave communications system is operating, communications are performed between the terminal 2, which is the master station, and the terminals 1 and 3 to 5, which are the slave stations, on the basis of a specified signal transmission method. The master station (the terminal 2) is made to transmit the signals received from one slave station to another slave station; thereby realizing communications between the slave stations via the master station.

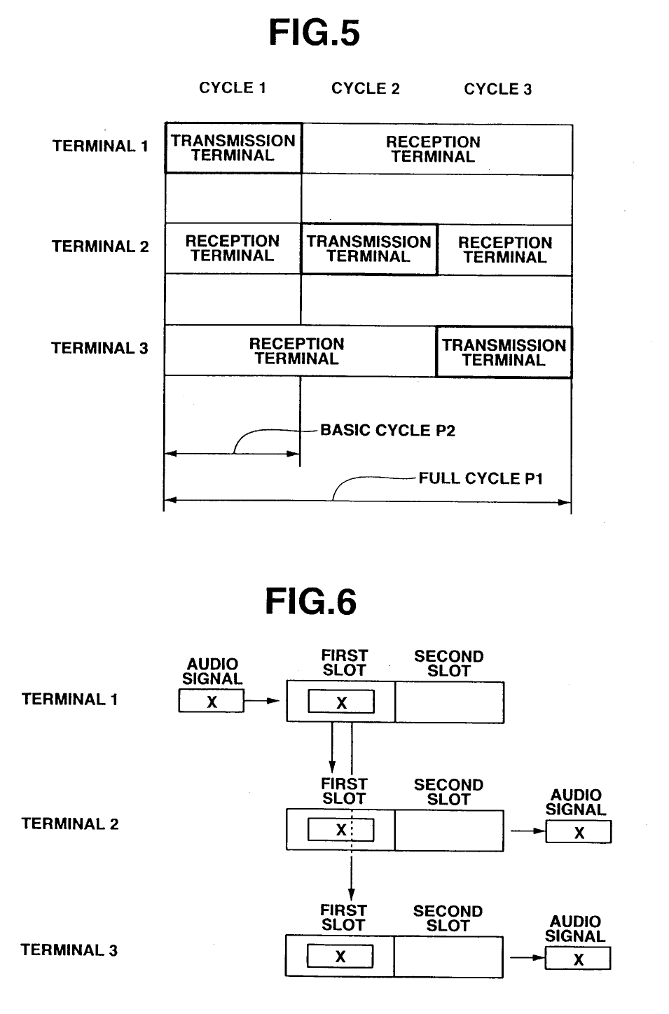

The signal transmission method to be adopted for the wireless terminal device of Embodiment 1, may be determined in accordance with the design of the system. Hereinafter explained is a case in which communications are performed with the TDMA method using four pairs of transmission and reception time slots (i.e. four communications channels) as shown in FIG. 5.

For example, when the terminal 1 and the terminal 4 perform one-to-one communications, the terminal 2 assigns, for example, a first channel (T1, R1) to the terminal 1 and a second channel (T2, R2) to the terminal 4. The terminal 2 transmits to the terminal 4 the audio signals received via the channel assigned to the terminal 1, via the channel assigned to the terminal 4. The terminal 2 also transmits to the terminal 1 the audio signals received via the channel assigned to the terminal 4, via the channel assigned to the terminal 1 (see FIG. 6).

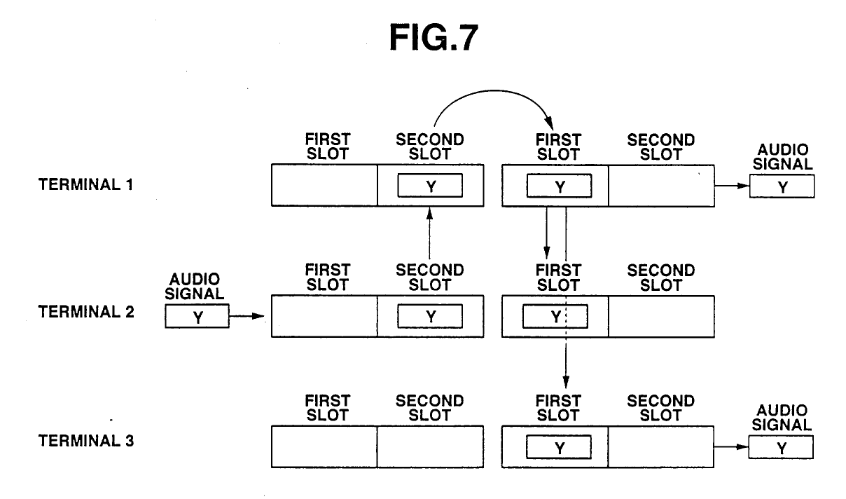

Moreover, for example, when one-to-N communications are performed between the terminals 1 to 5, the terminal 2 assigns a channel to the terminals 1 and 3 to 5, which are the slave stations. The terminal 2 controls the distribution in turns (or as necessary) of transmission authority to the respective terminals. When the terminal 2 receives the audio signal via the channel assigned to the terminal that was given transmission authority (or the audio signal that was input from the microphone 8 when the terminal 2 itself was given transmission authority), it transmits to the terminals that were not given transmission authority, the audio signal via the channels assigned to those terminals (see FIG. 7).

(Termination of Master/Slave Communications System)

A method of terminating the master/slave communications system can be determined in accordance with the design of the system. For example, in a conceivable method, when the terminal 1 which selected the master station candidate, or the terminal 2 operating in master station mode, or an arbitrary terminal, has the authority to terminate the system, and when it transmits a termination notification, the remaining terminals that received the notification, switch their modes from master station mode or slave station mode to standby mode etc.

(Others)

Another conceivable embodiment of this invention is a recording medium having an information processing program recorded thereon. Possible recording media that may be utilized include CD-ROMs, magnetic disks, semiconductors, or other recording media.

The data processor contained in a wireless terminal device reads the information processing program from the recording medium, and the program controls the operations of the data processor. When under control of the information processing program, the data processor realizes both the respective operation modes and the switching operations thereof in the master/slave communications system, which were explained in Embodiment 1.

This invention shall not be limited to the aforementioned embodiments, but may be modified in a variety of ways.

For example, the wireless terminal device can be structured in a manner that, during operation of the master/slave communications system, it can switch from master station mode to slave station mode, or from slave station mode to master station mode. In this case, in order not to cause master station conflicts within the group, it is necessary that the terminal that is going to switch from slave station mode to master station mode, should request to the terminal operating in master station mode to transit the master station, and when it has received permission, it switches from slave station mode to master station mode.

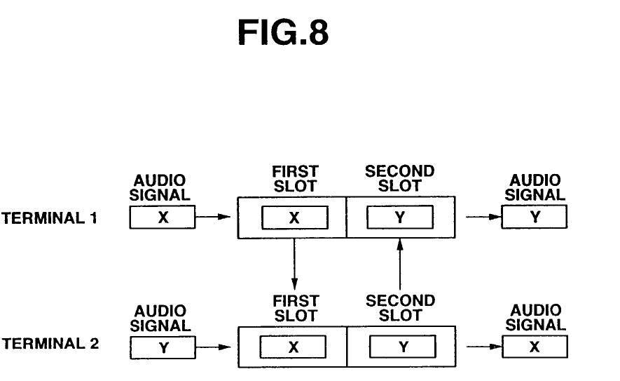

The structure of Embodiment 1 is such that the call-commencing terminal requests the other terminals to send their information of the numbers of communication-possible terminals, and the terminals that receive this request send their information of the numbers of communication-possible terminals in response to the request. This invention, however, shall not be limited to this structure. For example, an alternative structure may be adopted where, upon system synchronization using the heart-beat method, each terminal inserts their own information of the number of communication-possible terminals into the data (system synchronization data) to be transmitted. In this structure, each terminal can obtain the information of the number of communication-possible terminals of the respective terminals while operating in standby mode, therefore; the request and response sequence of the transmission of the information of the number of communication-possible terminals explained in Embodiment 1, can be omitted (see FIG. 8).

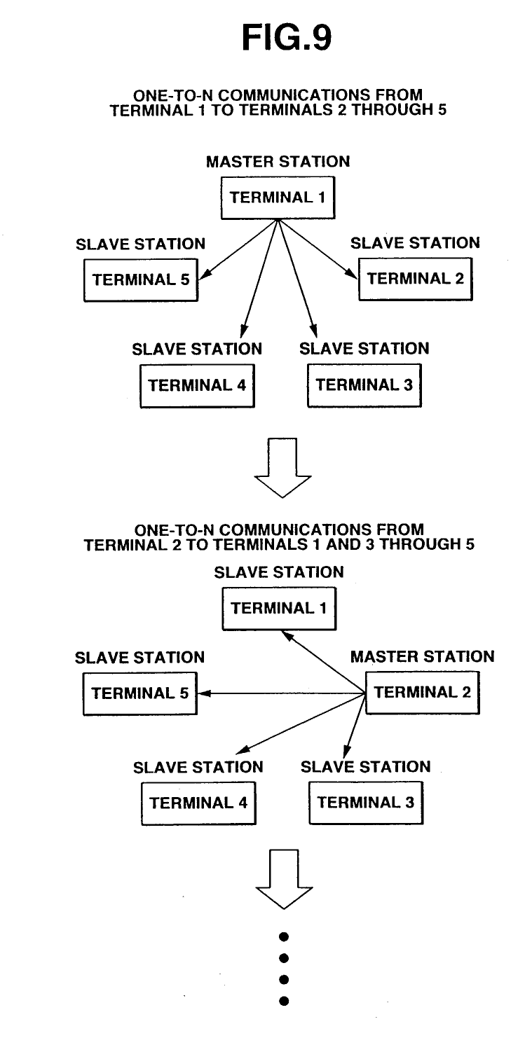

Moreover, the structure of Embodiment 1 is such that the master station candidate is selected on the basis of the number of communication-possible terminals. This invention, however, shall not be limited to this structure. For example, an alternative structure may be adopted where the master station candidate is selected so that the call-commencing terminal is able to communicate with the target terminal that it intends to communicate with. In this case, the respective terminals operating in standby mode store, as communication-possible terminal information, the identification numbers of the terminals that are able to receive the system synchronization data. The terminal that is going to make a call (i.e. starting terminal), requests that the other terminals send their communication-possible terminal information (identification information regarding communication-possible terminals), and the other terminals send their communication-possible terminal information in response to this request. The starting terminal receives this communication-possible terminal information from the respective terminals; selects the communication-possible terminal information that includes the identification information of the target terminal that the starting terminal intends to make a call to; and chooses a terminal corresponding to the selected information as the master station candidate (see FIG. 9). With this structure, the starting terminal can effectively broaden the communication-possible range by interposing the appropriate master station, thereby, enhancing the accuracy with which to communicate with the target terminal.

Finally, Embodiment 1 explains this invention by using the example of the communication system that consists of plural wireless terminal devices such as transceivers. However, this invention shall not be limited to such system. For example, this invention can also be applied to the wireless network such as the wireless LAN, as well as to communications systems where terminal devices are home electric appliances comprising data communications functions, for example, a video player, an audio system, a TV monitor, and a personal computer.

According to this invention, when the master/slave communications system (i.e. the communication system in which plural wireless terminals constitute a group and one terminal in the group becomes the master station while the remaining terminals become the slave stations, thereby performing communications between the master terminal and the slave terminals) is constructed, the effect of broadening the communication-possible range can be maximized by interposing the master station, on the basis of the selection criteria of the master station and the functions to select the master station based on the selection criteria.

The entire disclosure of Japanese Patent Application No. 2002-222825 filed on Jul. 31, 2002 including specification, claims, drawings and summary are incorporated herein by reference in its entirety.

What is claimed is:

1. A wireless terminal device, used in a communications system where a plurality of wireless terminal devices form a group, one terminal in the group becomes a master station, and the remaining terminals become slave stations, thereby performing communications between the master station and the slave stations,
wherein the wireless terminal device comprises switchable operation modes including at least: a standby mode for performing communications within the group and obtaining information regarding a terminal that is able to communicate with its own terminal (hereinafter referred to as the “communication-possible terminal information”); a master station mode for operating as the master station; and a slave station mode for operating as the slave station, and
wherein, the wireless terminal device further comprises:
a first unit for obtaining another terminal's communication-possible terminal information, selecting a candidate terminal for the master station on the basis of the respective terminals' communication-possible terminal information, and notifying other terminals of the selection results; and
a second unit for, on the basis of the selection results, switching its mode to the master station mode when its own terminal is selected as the candidate terminal for the master station, and switching its mode to slave station mode when its own terminal is not selected as such.

2. The wireless terminal device according to claim 1, wherein the communication-possible terminal information includes information of the number of terminals that are able to communicate with its own terminal.

3. The wireless terminal device according to claim 1, wherein the communication-possible terminal information includes identification information of a terminal that is able to communicate with its own terminal.

4. The wireless terminal device according to claim 1, wherein, on the basis of the transmission timing assigned to the respective terminals in the group, when the terminal is in the standby mode, it transmits a signal at the timing assigned to its own terminal; receives a signal at the timing assigned to another terminal; and adjusts the transmission and reception timing on the basis of the received signal.

5. The wireless terminal device according to claim 4, wherein the signal includes the communication-possible terminal information.

6. A communications system where a plurality of wireless terminal devices form a group, one terminal in the group becomes a master station, and the remaining terminals become slave stations, thereby performing communications between the master station and the slave stations,
wherein the wireless terminal device comprises switchable operation modes including at least: a standby mode for performing communications within the group and obtaining information regarding a terminal that is able to communicate with its own terminal (hereinafter referred to as the “communication-possible terminal information”); a master station mode for operating as the master station; and a slave station mode for operating as the slave station, and
wherein, the wireless terminal devices further comprises:
a first unit for obtaining another terminal's the communication-possible terminal information, selecting a candidate terminal for the master station on the basis of the respective terminals' communication-possible terminal information, and notifying other terminals of the selection results; and
a second unit for, on the basis of the selection results, switching its mode to the master station mode when its own terminal is selected as the candidate terminal for the master station, and switching its mode to slave station mode when its own terminal is not selected as such.

7. A communication control method of a wireless terminal device, used for a communications system where a plurality of wireless terminal devices form a group, one terminal in the group becomes a master station, and the remaining terminals become slave stations, thereby performing communications between the master station and the slave stations,
wherein the method comprises the steps of:
performing communications within the group and obtaining information regarding a terminal that is able to communicate with its own terminal (hereinafter referred to as the “communication-possible terminal information”);
obtaining another terminal's communication-possible terminal information, selecting a candidate terminal for the master station on the basis of the respective terminals' communication-possible terminal information, and notifying other terminals of the selection results; and
switching its mode, on the basis of the selection results, to master station mode when its own terminal is selected as the candidate terminal for the master station, and to slave station mode when its own terminal is not selected as such.

8. A communication control method, used for a communications system where a plurality of wireless terminal devices form a group, one terminal in the group becomes a master station, and the remaining terminals become slave stations, thereby performing communications between the master station and the slave stations,
wherein the method comprises:
a step in which each terminal performs communications within the group and obtains information regarding a terminal that is able to communicate with its own terminal (hereinafter referred to as the “communication-possible terminal information”);
a step in which a first terminal obtains another terminal's communication-possible terminal information;
selects a candidate terminal for the master station on the basis of the respective terminals' communication-possible terminal information; and notifies other terminals of the selection results; and
a step in which each terminal switches its mode, on the basis of the selection results, to master station mode when its own terminal is selected as the candidate terminal for the master station, and to slave station mode when its own terminal is not selected as such.

9. A program for making a computer installed in a wireless terminal device execute the communication control method according to claim 7 or 8.
